(19) United States
(12) Patent Application Publication
(10) Pub. No.: US 2012/0029679 A1
(43) Pub. Date: Feb. 2, 2012

(54) DEFECT ANALYSIS METHOD OF SEMICONDUCTOR DEVICE

(75) Inventor: Hiroshi Matsushita, Mie-ken (JP)

(73) Assignee: KABUSHIKI KAISHA TOSHIBA, Tokyo (JP)

(21) Appl. No.: 13/177,127

(22) Filed: Jul. 6, 2011

(30) Foreign Application Priority Data
Jul. 6, 2010 (JP) P2010-153680

(51) Int. Cl. G06F 19/00

(52) U.S. Cl. 700/110

(57) ABSTRACT

A defect analysis method of semiconductor device, wherein defect percentage data for each of inspection units within a wafer and information pieces regarding manufacturing conditions for the wafer are loaded into a computer; statistical testing of the defect percentage data with respect to the manufacturing conditions is performed using the computer; and results of the statistical testing are collected for each of the information pieces on the manufacturing conditions and outputted from the computer.

### CROSS REFERENCE TO RELATED APPLICATION

This application is based upon and claims the benefit of priority from Japanese Patent Application No. 2010-153680, filed on Jul. 6, 2010, the entire contents of which are incorporated herein by reference.

### BACKGROUND

To improve the production yield of a semiconductor device, it is important to analyze yield loss, determine a process, a manufacturing apparatus, a design condition, or the like which is a cause thereof early, and make a refinement. However, a semiconductor device is produced by several hundred manufacturing steps and manufacturing apparatuses. For this reason, when a defect occurs once, identifying a cause thereof is generally a very demanding task.

In general, in semiconductor device manufacture, after the completion of a wafer process, desired inspections for electrical characteristics are performed. The inspections are performed on chips in a wafer state by bringing probes into contact with the chips. Displaying within a surface of the wafer the position of a chip determined to be defective in a specific test as a result of an inspection makes it possible to see at which position on the wafer a defect has occurred. This is called a wafer map.

The distribution of defective chips displayed on the wafer map is broadly classified into two categories: a random defect in which defective chips are scattered evenly without depending on positions on the wafer surface, and a clustering defect in which defective chips disproportionately occur somewhere on the wafer. Here, a defect caused by a specific process or manufacturing apparatus appears as a unique distribution on the wafer map. That is to say, in the case where a malfunction has occurred in a certain process or manufacturing apparatus, a clustering defect intrinsic to the process or manufacturing apparatus occurs.

However, there are a wide range of defect causes. Defects on the wafer map in which all the defect causes are integrated include defects occurring due to various causes. Thus, in an investigation of causes which covers defects across the wafer, a plurality of defect causes are included at the same time, and it is difficult to statistically identify a causative apparatus. Moreover, in the case of a defect pattern having a small size, it is also difficult to detect the defect pattern and identify a cause thereof.

### SUMMARY

Aspects of the invention relate to a defect analysis method of semiconductor device.

In one aspect of the invention, a defect analysis method of semiconductor device, wherein defect percentage data for each of inspection units within a wafer and information pieces regarding manufacturing conditions for the wafer are loaded into a computer; statistical testing of the defect percentage data with respect to the manufacturing conditions is performed using the computer; and results of the statistical testing are collected for each of the information pieces on the manufacturing conditions and outputted from the computer.

In another aspect of the invention, a defect analysis method for a semiconductor device, comprising the steps of: loading defect percentage data for each of inspection units within a wafer and an information piece for identifying a manufacturing apparatus which has processed the wafer from a database into a computer; performing statistical testing of the defect percentage data with respect to the manufacturing apparatus using the computer; and outputting results of the statistical testing for the information on the manufacturing apparatus from the computer in the form of map data corresponding to positions within a surface of the wafer.

### BRIEF DESCRIPTIONS OF THE DRAWINGS

A more complete appreciation of the invention and many of the attendant advantages thereof will be readily obtained as the same becomes better understood by reference to the following detailed description when considered in connection with the accompanying drawings.

FIG. 1 is a flowchart illustrating a schematic flow of a defect analysis method for a semiconductor device according to a first embodiment.

FIG. 2 is a block diagram showing one example of a system configuration for implementing the defect analysis method for a semiconductor device according to this embodiment.

FIG. 3 is a flowchart showing one specific flow of the defect analysis method for a semiconductor device according to this embodiment.

FIG. 4 is a view showing an example in which chip defect percentages are displayed in a map format.

FIG. 5 is a view showing an example of processing history information.

FIG. 6 is a view showing an example of test/processing history matching information.

FIG. 7 is a view showing an example of a list of chip coordinates, manufacturing steps, and manufacturing apparatuses determined to be significant in statistical testing.

FIG. 8 is a view showing an example of display on a wafer map.

FIG. 9 is a view illustrating coordinates of defective chips determined to be significant.

FIG. 10 is a view illustrating coordinates of defective chips determined to be significant.

FIG. 11 is a view illustrating coordinates of defective chips determined to be significant.

### DETAILED DESCRIPTION

Various connections between elements are hereinafter described. It is noted that these connections are illustrated in general and, unless specified otherwise, may be direct or indirect and that this specification is not intended to be limiting in this respect.

Embodiments of the present invention will be explained with reference to the drawings as next described, wherein like reference numerals designate identical or corresponding parts throughout the several views.

### First Embodiment

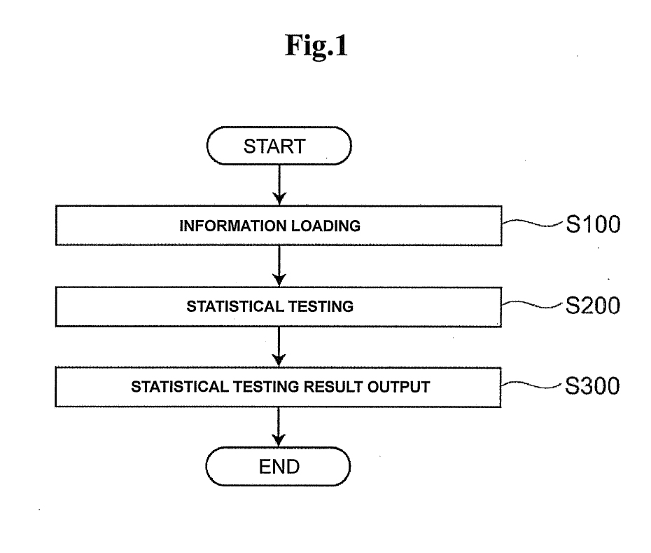

FIG. 1 is a flowchart illustrating a schematic flow of a defect analysis method for a semiconductor device according to a first embodiment.

To be specific, the defect analysis method for a semiconductor device according to this embodiment includes information loading (step S100), statistical testing (step S200), and statistical testing result output (step S300).

In the information loading (step S100), defect percentage data for each of inspection units within a wafer, which has the same size as a chip area or has a smaller size than the chip area, and information pieces regarding manufacturing conditions for the wafer, are loaded into a computer.

Here, the term “chip area” refers to each of areas into which a wafer is diced by cutting the wafer along dicing lines after manufacturing and inspection steps in a wafer are finished.

The inspection unit is an area which has the same size as the chip area defined above or has a smaller size than the chip area. It should be noted that in this embodiment, a description will be made by assuming the chip area to be the inspection unit.

Moreover, the term “manufacturing condition” refers to information regarding a history of processing performed on the wafer, such as manufacturing apparatuses which have processed the wafer, materials used, processing conditions, and processing date and time.

In the statistical testing (step S200), statistical testing of the defect percentage data loaded in advance with respect to the manufacturing conditions is performed using the computer.

Statistical testing is a statistical calculation which is performed to determine whether or not the defect percentage data for each inspection unit is significantly high when processing is performed by a specific step or manufacturing apparatus. In this embodiment, statistical testing is performed using a chi-square testing value.

In the statistical testing result output (step S300), results of the statistical testing performed in advance are collected for each of the information pieces on the manufacturing conditions and outputted from the computer.

As to the statistical testing result output, for example, the results of the statistical testing are outputted such that the results are sorted for each of the information pieces on the manufacturing conditions, or the results of the statistical testing are outputted in the form of map data corresponding to positions within a surface of the wafer.

In the above-described defect analysis method for a semiconductor device according to this embodiment, an analysis as to which manufacturing condition has caused a defect in the wafer is made on an inspection unit basis. Moreover, since the results of the statistical testing are associated with manufacturing conditions, a defect specific to a manufacturing condition can be appropriately extracted.

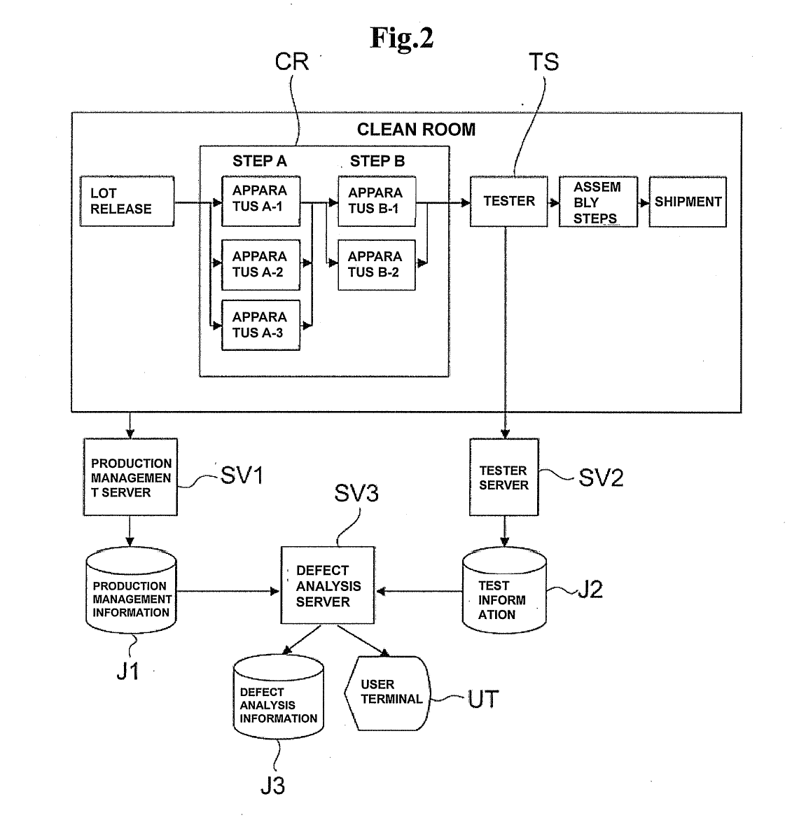

FIG. 2 is a block diagram showing one example of a system configuration for implementing the defect analysis method for a semiconductor device according to this embodiment.

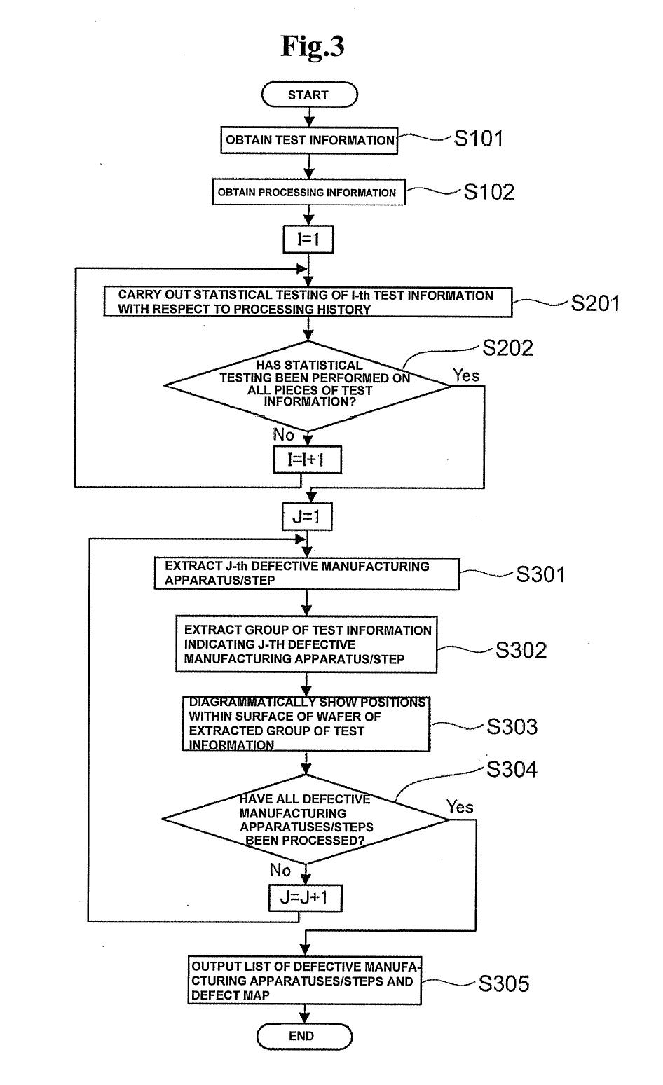

FIG. 3 is a flowchart showing one specific flow of the defect analysis method for a semiconductor device according to this embodiment.

As shown in FIG. 2, the system configuration for implementing this embodiment includes a production management server SV1, a tester server SV2, a defect analysis server SV3, and the user terminal UT.

The production management server SV1 manages processing in each step of a semiconductor manufacturing line to be managed. In the semiconductor manufacturing line illustrated in FIG. 2, for example, a plurality of manufacturing apparatuses (e.g., A-1, A-2, A-3, are disposed in a clean room CR, and a tester TS which performs inspections for predetermined electrical characteristics and the like in a wafer state is provided in a subsequent stage of the clean room CR.

The production management server SV1 manages the following steps: releasing lots into the semiconductor manufacturing line, manufacturing steps, inspection steps by the tester TS, assembly steps, and shipment. For example, the production management server SV1 manages numbers of released lots and wafer numbers in each lot. Moreover, in the manufacturing steps, the production management server SV1 performs operation management such as the management of manufacturing conditions in the manufacturing apparatuses corresponding to each lot and each wafer, and of information for identifying a manufacturing apparatus. Moreover, in the inspection steps, operation management is performed using the tester TS corresponding to an inspection unit such as a lot, a wafer, or a chip. Moreover, in the assembly steps, the production management server SV1 manages dicing, packaging, packing, and the like. Moreover, in the shipment step, the production management server SV1 manages the shipment of products (semiconductor devices) corresponding to a lot, a wafer, and a chip.

The production management server SV1 performs the above-described various kinds of management using production management information J1.

The tester server SV2 manages items and results of inspections to be performed by the tester TS. Inspection samples are brought in the tester TS in units of wafers. The tester server SV2 executes various inspections and collects inspection results in association with the positions of inspection units on each wafer. The tester server SV2 outputs inspection results for the inspection samples as test information J2.

The defect analysis server SV3 performs a defect analysis using the production management information J1 which is used by the production management server SV1 and the test information J2 which is outputted by the tester server SV2, and outputs defect analysis information J3. The defect analysis information J3 is displayed on the user terminal UT in a desired format.

In this embodiment, a program which is executed on a defect analysis server is used to collect the results of the statistical testing for each of the information pieces on the manufacturing conditions (manufacturing apparatus, materials, manufacturing date and time, and the like), and to specify the manufacturing condition which has caused an anomaly in yield. Moreover, the position on the wafer of the inspection unit in which the anomaly in yield is caused by the identified manufacturing condition is identified.

Next, a specific flow of manufacturing steps by the semiconductor manufacturing line shown in FIG. 2 will be described.

The semiconductor manufacturing steps start with a lot releasing step in which wafers are released into the clean room CR. The wafers in the released lot undergo the manufacturing steps (steps A, B, to be removed from the clean room CR. The removed wafers are inspected for desired electrical characteristics in a wafer state, or are inspected for electrical characteristics for each of the inspection units. The inspected wafer is diced into chips in a dicing step. Moreover, chips having desired electrical characteristics are packaged to be shipped as products.

Here, a plurality of manufacturing apparatuses having the same processing ability are disposed for each manufacturing step. Thus, a plurality of wafer can be processed in parallel. Wafers are processed in units called lots, each of which generally includes 25 wafers. The production management server SV1 manages when and by which manufacturing apparatus each lot is processed in each step, and stores the processing history information as the production management information J1 in a database.

On the other hand, the wafers removed from the clean room CR undergo electrical inspections by the tester TS. Results of the inspections are collected by the tester server SV2 and stored in a database as the test information J2.

In the manufacturing steps by such a semiconductor manufacturing line, in this embodiment, the defect analysis server SV3 performs a defect analysis using the production management information J1 and the test information J2. Thus, a manufacturing condition which has caused an anomaly in yield is identified, and a position in which a defect has occurred due to the manufacturing condition is identified on an inspection unit basis.

Next, an operating algorithm for a defect analysis by the defect analysis server SV3 will be described with reference to the flowchart of FIG. 3.

First, the defect analysis server SV3 obtains the test information J2 from the tester server SV2 (FIG. 3: step S101). In this embodiment, a defect percentage is obtained for each test type. The defect percentage is obtained on an inspection unit basis. Moreover, a chip defect percentage is used as the defect percentage. The chip defect percentage represents the defect percentage for each chip location on the wafer surface, and, in this embodiment, is found as the percentage of the number of wafers in the lot which have failed at each chip location when wafers in the lot are superposed. For example, in the case where there is a wafer which is determined to be defective at chip coordinates (12, 15) in electrical test A, and where the total number of wafers in the lot is 25, the chip defect percentage for electrical test A at chip coordinates (12, 15) in this lot is calculated as 1/25=4%.

When chip defect percentages are displayed in a map format on the wafer surface according to chip coordinates, the trend of the lot as to where on the wafer surface defects frequently occur can be found out.

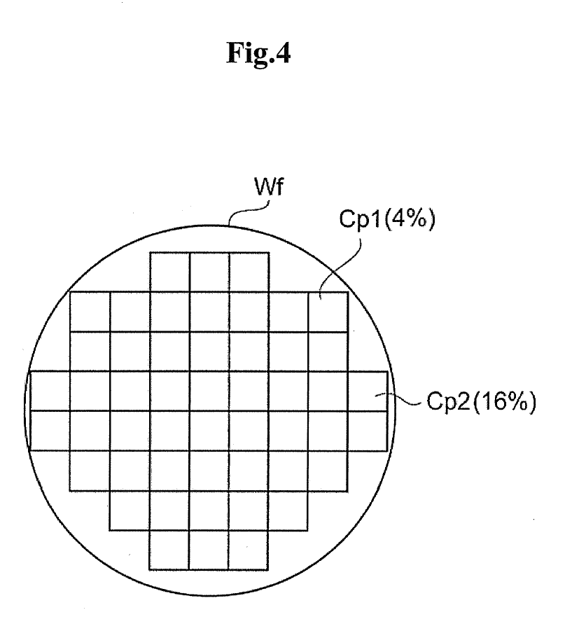

FIG. 4 is a view showing an example in which chip defect percentages are displayed in a map format.

In FIG. 4, as one example, defect percentages for two chips Cp1 and Cp2 within a surface of a wafer Wf are indicated. For example, the defect percentage for the chip Cp1 is 4%, and the defect percentage for the chip Cp2 is 16%. As described above, a chip defect percentage is found for each set of chip coordinates within the surface of the wafer Wf.

Next, the defect analysis server SV3 obtains the production management information J1 from the production management server SV1 (FIG. 3: step S102). The production management information J1 contains processing history information. The processing history information indicates which manufacturing apparatus each lot has been processed in each step.

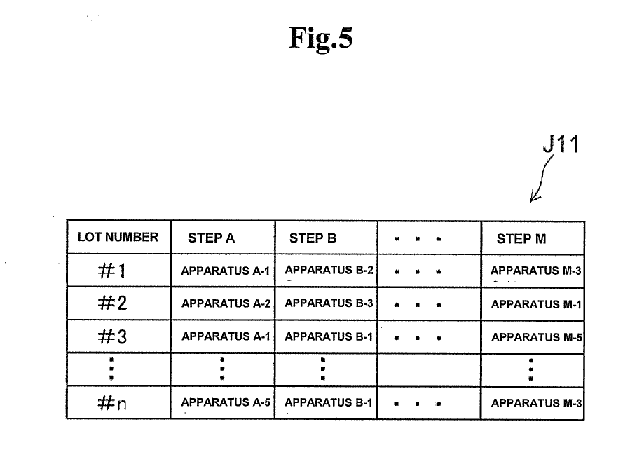

FIG. 5 is a view showing an example of processing history information.

It should be noted that though processing history information J11 is represented in a table format in FIG. 5 for the sake of convenience to facilitate the understanding thereof, the information only needs to be in a form in which pieces of information in rows and columns of the table are associated with each other.

In the processing history information J11, the row direction corresponds to lot numbers (#1, #2, #3, . . . , #n), and the column direction corresponds to step A, step B, . . . , step M. In each column in each row, information on a manufacturing apparatus used is recorded. For example, it can be seen that wafers of lot number #1 are processed by the manufacturing apparatus A-1 in step A, processed by the manufacturing apparatus B-2 in step B, . . . , and processed by the manufacturing apparatus M-3 in step M.

Next, the defect analysis server SV3 carries out statistical testing with respect to all the test information J2 and the processing history information J11 (FIG. 3: step S201). To do this, test/processing history matching information is created in which the test information J2 and the processing history information J11 are collated with lot numbers.

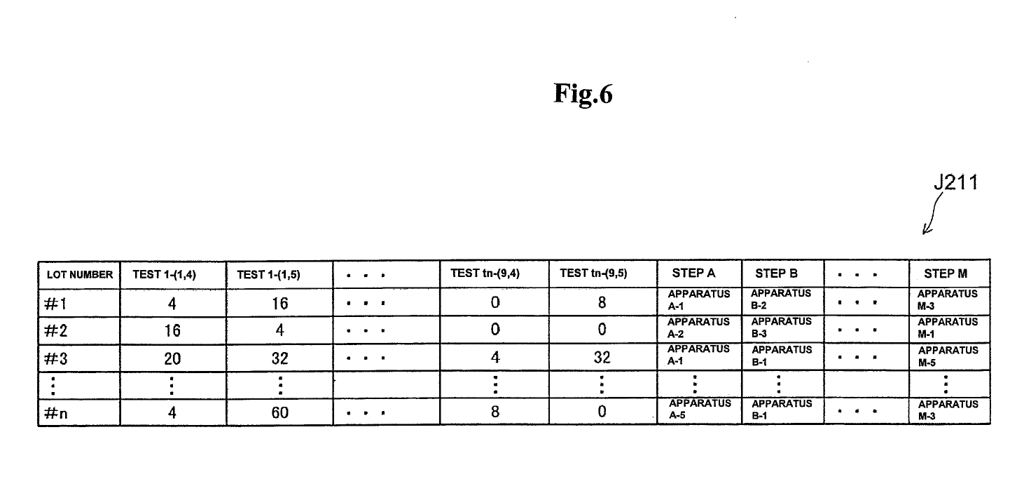

FIG. 6 is a view showing an example of test/processing history matching information.

It should be noted that though test/processing history matching information J211 is represented in a table format in FIG. 6 for the sake of convenience to facilitate the understanding thereof, the information only needs to be in a form in which pieces of information in rows and columns of the table are associated with each other.

In the test/processing history matching information J211, the row direction corresponds to lot numbers (#1, #2, #3, . . . , #n), and the column direction corresponds to test types and manufacturing steps. The left half of the first row shows test types and chip coordinates, and the right half of the first row shows manufacturing steps.

Each row of each of the columns of test types and chip coordinates shows a chip defect percentage. Moreover, each row of each of the columns of manufacturing steps shows processing history information (e.g., the name of a manufacturing apparatus which has performed processing) on each manufacturing step.

Next, the defect analysis server SV3 carries out statistical testing of chip defect percentages with respect to the processing history information J11. Statistical testing is performed to determine whether or not a chip defect percentage for each chip location is significantly high when processing is performed by a specific step (manufacturing apparatus). In this embodiment, the median of chip defect percentages for each chip location is denoted by mf. A lot in which a chip defect percentage is higher than mf is identified as a defective lot with regard to the relevant chip defect, and a lot in which a chip defect percentage is lower than mf is identified as a normal lot with regard to the relevant chip defect.

Here, a statistical testing algorithm will be described which is used in this embodiment.

The total number of lots is denoted by n. It is assumed that a number me of manufacturing apparatuses are used in a certain step L. The number of lots processed by a manufacturing apparatus i (i=1, 2, . . . , me) is denoted by pi. The total number of defective lots, each of which has a chip defect percentage for chip coordinates (cx, cy) higher than the median mf of chip defect percentages for the chip coordinates is denoted by nf. Then, an expected value Ei of the number of defective lots for the manufacturing apparatus i is

Ei=pi×nf/n

The actual value of the number of defective lots processed by the manufacturing apparatus i in the step of interest which is found from the test/processing history matching information shown in FIG. 6 is denoted by Oi. Then, the chi-square statistic X2 is represented as

X2=Σ(Oi−Ei)²/Ei

Here, Σ denotes the operation of taking a sum for all manufacturing apparatuses (i=1, 2, . . . , me) for the step of interest.

The X2 value follows the chi-square distribution with me−1 degrees of freedom. Accordingly, a chi-square testing value P is expressed as

P=Chidist(X2, me−1)

Here, Chidist represents the chi-square distribution function.

In this embodiment, statistical testing is carried out with respect to combinations of all the chip defect percentages to be processed and all the manufacturing steps (FIG. 3: steps S201 to S202). Further, a threshold value is set for the chi-square testing value, and a significant chip defect percentage-step combination is extracted (FIG. 3: steps S301 to S304). In this embodiment, as one example, cases where the chi-square testing value P is smaller than 0.05 are extracted as significant cases.

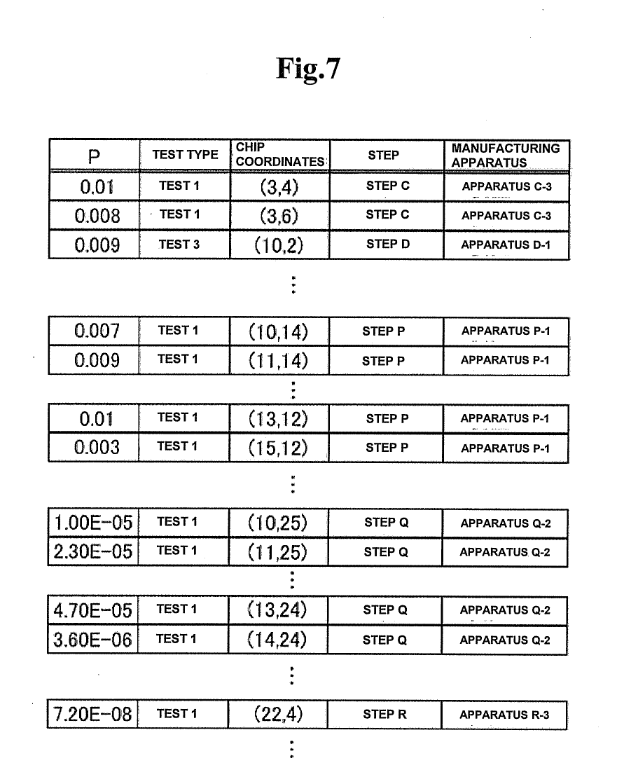

FIG. 7 is a view showing an example of a list of chip coordinates, manufacturing steps, and manufacturing apparatuses determined to be significant in the statistical testing.

It should be noted that though determination results are represented in a table format in FIG. 7 for the sake of convenience to facilitate the understanding thereof, the information only needs to be in a form in which pieces of information in rows and columns of the table are associated with each other.

In the determination results shown in FIG. 7, test types, chip coordinates, manufacturing steps, and manufacturing apparatuses determined to be significant are displayed along with the chi-square testing value P.

Here, the number of results of the statistical testing in this embodiment comes to an enormous number. For example, if it is assumed that the total number of chips per wafer is 100, and that the number of test types is 10, the number of columns of chip defect percentages shown in FIG. 6 is 100×10=1000. Furthermore, if it is assumed that the total number of steps is 100, the number of times of statistical testing is 1000×100=100,000. For example, if 10% thereof is significant, the number of rows of the results of determination shown in FIG. 7 is approximately 10,000.

In significance testing results illustrated in FIG. 7, there are cases where the same manufacturing step (manufacturing apparatus) is extracted according to defect percentages corresponding to a plurality of sets of chip coordinates. For example, as to the manufacturing apparatus C-3 for step C, it can be seen that chip defect percentages are significantly high for chip coordinates (3, 4) in test 1 and for chip coordinates (3, 6) in test 1. Moreover, as to the manufacturing apparatus D-1 for step D, it can be seen that a chip defect percentage is significantly high for chip coordinates (10, 2) in test 3.

Accordingly, test types and chip coordinates for chip defect percentages corresponding to the same manufacturing step (manufacturing apparatus name) are extracted from significance testing results illustrated in FIG. 7, and these are displayed on a wafer map (FIG. 3: step S305).

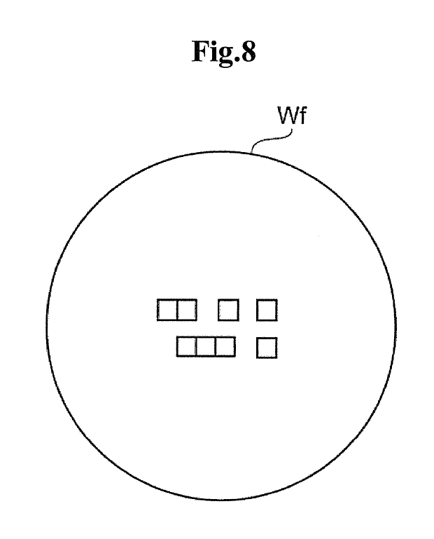

FIG. 8 is a view showing an example of display on a wafer map. It should be noted that though determination results are represented in a map format having the shape of a wafer in FIG. 8 for the sake of convenience to facilitate the understanding thereof, the information only needs to be in a form in which pieces of information on the chip coordinates on the map are associated with each other. The wafer map is displayed on a screen of the user terminal UT. In other words, the user terminal UT receives the selection of a desired manufacturing step and a manufacturing apparatus by a user. The user terminal UT sends the manufacturing step selected by the user and the selection of the manufacturing apparatus to the defect analysis server SV3. The defect analysis server SV extracts, in accordance with user's selection sent from the user terminal UT, information on the manufacturing step and the manufacturing apparatus corresponding to the selection from the list illustrated in FIG. 7. Further, results of extraction are outputted to the user terminal UT as a wafer map. The user terminal UT displays the wafer map sent from the defect analysis server SV on the screen.

FIG. 8 is a view in which for the manufacturing apparatus P-1 that performs the processing of step P illustrated in FIG. 7, coordinates of defective chips determined to be significant are indicated by squares. In this example,, it is illustrated that within the surface of the wafer Wf, chip defect percentages in test 1 mostly exist in a central portion of the wafer, and shows a defect pattern including lines of defective chips with a nondefective line interposed therebetween. Referring to this wafer map, it can be seen that an apparatus which is causative of a periodic defect in a central portion of the wafer in test 1 is the manufacturing apparatus P-1 for step P.

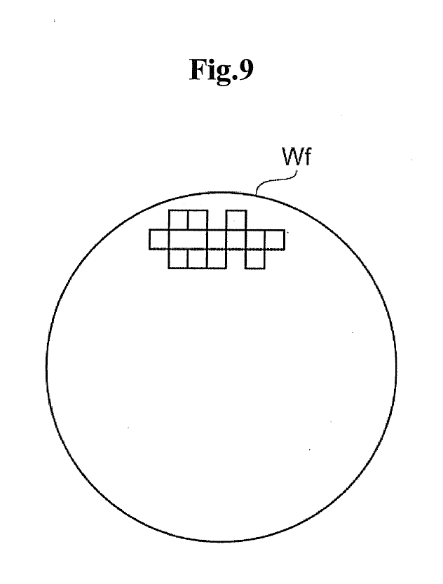

FIG. 9 is a view in which for the manufacturing apparatus Q-2 that performs the processing of step Q, coordinates of defective chips determined to be significant are indicated by squares. In this example, it is illustrated that within the surface of the wafer Wf, chip defect percentages in test 1 mostly exist in a peripheral portion of the wafer. Referring to this wafer map, it can be seen that an apparatus which is causative of a defect in a peripheral portion of the wafer in test 1 is the manufacturing apparatus Q-2 for step Q.

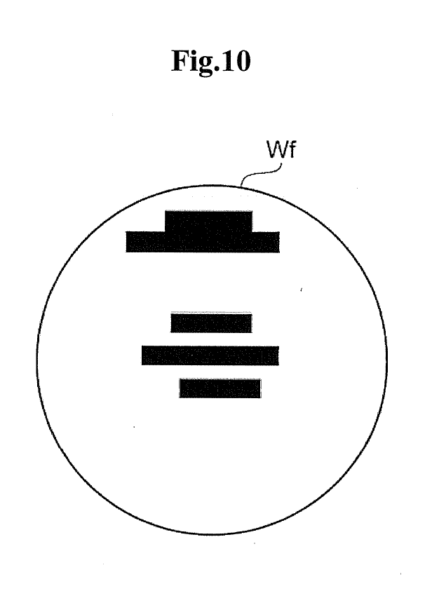

Here, both FIGS. 8 and 9 show results for test 1. FIG. 10 shows one example of the distribution of chip defects in an actual lot. The lot shown in FIG. 10 is processed by the manufacturing apparatus P-1 in step P and processed by the manufacturing apparatus Q-2 in step Q. Test 1 is one of electrical tests, and FIG. 10 shows a wafer map of chips determined to be defective in test 1 as an example. In the wafer map illustrated in FIG. 10, a periodic pattern at the wafer center and a peripheral pattern which indicate defects of test 1 appear within the surface of the wafer Wf in a mixed manner. In such a case, it is difficult to identify a causative step (manufacturing apparatus) by statistical testing using defect information on the entire wafer surface.

On the other hand, in this embodiment, statistical testing is performed based on classification into chip locations. Accordingly, even in the case where wafer defects exist in both of a central portion and a peripheral portion and where causes thereof are different from each other, the causes can be identified by classifying positions of occurrence for each of the defect patterns into chip locations.

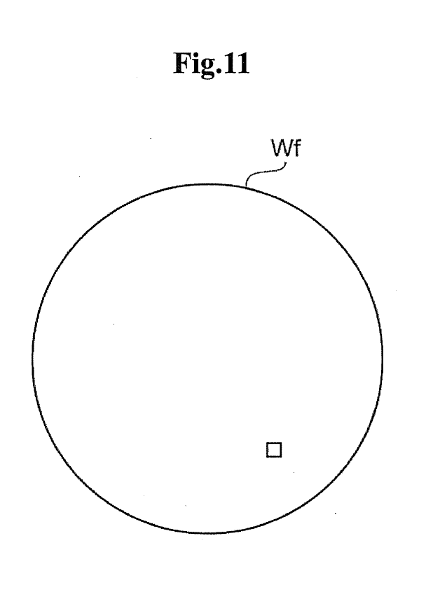

FIG. 11 is a view showing an example of another wafer map. In this example, a defect occurs only in a specific one chip within the surface of the wafer Wf. From the significance testing results illustrated in FIG. 7, it is identified that a cause of the defect is the manufacturing apparatus R-3 for step R. In this example, only this one chip indicates the manufacturing apparatus R-3 for step R. For such a very small defect pattern, it is difficult to identify a causative step (manufacturing apparatus) by statistical testing using defect information on the entire wafer surface. On the other hand, in this embodiment, even for a defect of only one chip location, a cause thereof can be identified with high sensitivity.

As described above, according to this embodiment, by statistical testing using respective defect percentages for chip locations, a defect pattern can be identified from chip coordinates of chip defect percentages indicating the same manufacturing step (manufacturing apparatus). Accordingly, even for a defect pattern in which causes are mixed or a small defect pattern, a step (manufacturing apparatus) which is causative thereof can be identified with high accuracy.

It should be noted that with regard to the output format of the defect analysis information J3, the defect analysis server SV3 may output the defect analysis information J3 in a list format such as illustrated in FIG. 7 in which items are sorted for each of information pieces on the manufacturing conditions, other than a format using a wafer map such as described above. The user terminal UT receives the defect analysis information J3 outputted from the defect analysis server SV3, and displays results of an analysis in a wafer map format or a list format.

Moreover, the conversion of display formats such as the wafer map format and the list format may be performed by the user terminal UT. In other words, the user terminal UT receives the defect analysis information J3 from the defect analysis server SV3, and extracts and sorts necessary information in accordance with a request from a user. Then, the necessary information is displayed in a way which facilitates analysis.

Moreover, a method for extracting desired information from the defect analysis information J3 is not limited to the method described previously. In the example described previously, in the case where a desired manufacturing condition is selected by a user, only this manufacturing condition is extracted from the information in the list illustrated in FIG. 7, and coordinates of defective chips are displayed in the form of a wafer map or a list.

On the other hand, in the case where desired chip coordinates are selected by a user, only the information corresponding to the chip coordinates may be extracted from the information in the list illustrated in FIG. 7, and manufacturing conditions which are causes of a defect may be displayed in the form of a list.

### Second Embodiment

A defect analysis method for a semiconductor device according to a second embodiment is a method in which statistical testing (FIG. 1: step S200) and statistical testing result output (FIG. 1: step S300) in the defect analysis method for a semiconductor device according to first embodiment described previously are performed in parallel.

In other words, in the first embodiment, statistical testing (FIG. 1: step S200, FIG. 3: steps S201 to S202) is performed with respect to all the test information and the processing history information, and, after that, statistical testing result output (FIG. 1: step S300, FIG. 3: steps S301 to S305) is performed.

On the other hand, in the second embodiment, in statistical testing, a chi-square testing value P is found using a combination of a chip defect percentage in one chip location and a manufacturing step (manufacturing apparatus). In parallel with this, whether or not the combination is significant is determined using the chi-square testing value P, and, if it is determined that the combination is significant, the combination is registered in the list shown in FIG. 7. That is to say, during statistical testing, a determination of significance using results of the test and registration in the list are performed in parallel.

Performing statistical testing and statistical testing result output in parallel as described above can reduce the time required for defect analysis processing.

It should be noted that though the case where the inspection unit is one chip is taken as an example in the above-described embodiment, an inspection unit smaller than one chip may also be employed in the present invention. For example, in the case where a specific area within a chip is used as an inspection unit, if the coordinates within the surface of the wafer of the inspection unit are defined, a causative step (manufacturing apparatus) can be identified on an inspection unit basis by performing significance testing in a similar manner. Moreover, though a description has been made in the above-described embodiment by taking as an example the case where targets of statistical testing are manufacturing steps (manufacturing apparatuses), statistical testing may be performed on other processing conditions (materials to be used, processing conditions, processing date and time, or the like).

As described above, in the defect analysis method for a semiconductor device according to this embodiment, a cause of a defect pattern can be identified with high accuracy. In other words, in this embodiment, by statistical testing using respective defect percentages for inspection units, a defect pattern is identified from coordinates of inspection units having defect percentages indicating the same manufacturing step, and manufacturing condition. Thus, even for a defect pattern in which various causes are mixed or a small defect pattern, a cause thereof can be identified with high accuracy.

Although embodiments of the present invention have been described, these embodiments are presented as examples and not intended to limit the scope of the invention. These novel embodiments can be carried out in other various ways, and various omissions, substitutions, and alterations can be made without departing from the spirit of the invention. These embodiments and modifications thereof are included in the scope and spirit of the invention and in the scope of the invention defined in the appended claims and equivalents thereof.

what is claimed is:

1. A defect analysis method for a semiconductor device,
wherein
defect percentage data for each of inspection units within a wafer and information pieces regarding manufacturing conditions for the wafer are loaded into a computer;
statistical testing of the defect percentage data with respect to the manufacturing conditions is performed using the computer; and
results of the statistical testing are collected for each of the information pieces on the manufacturing conditions and outputted from the computer.

2. The defect analysis method according to claim 1, wherein the computer outputs the results of the statistical testing such that the results are sorted for each of the information pieces regarding the manufacturing conditions.

3. The defect analysis method according to claim 1, wherein the computer outputs the results of the statistical testing in the form of map data corresponding to positions within a surface of the wafer.

4. The defect analysis method according to any one of claims 1, wherein the computer receives selection of the information pieces on the manufacturing conditions, and extracts and outputs information regarding the statistical testing with respect to the received information regarding the manufacturing conditions.

5. The defect analysis method according to any one of claims 2, wherein the computer receives selection of the information pieces on the manufacturing conditions, and extracts and outputs information regarding the statistical testing with respect to the received information regarding the manufacturing conditions.

6. The defect analysis method according to any one of claims 3, wherein the computer receives selection of the information pieces on the manufacturing conditions, and extracts and outputs information regarding the statistical testing with respect to the received information regarding the manufacturing conditions.

7. The defect analysis method according to any one of claims 1, wherein each of the information pieces regarding the manufacturing conditions is information for identifying a manufacturing apparatus which has processed the wafer.

8. The defect analysis method according to any one of claims 2, wherein each of the information pieces regarding the manufacturing conditions is information for identifying a manufacturing apparatus which has processed the wafer.

9. The defect analysis method according to any one of claims 3, wherein each of the information pieces regarding the manufacturing conditions is information for identifying a manufacturing apparatus which has processed the wafer.

10. The defect analysis method according to any one of claims 4, wherein each of the information pieces regarding the manufacturing conditions is information for identifying a manufacturing apparatus which has processed the wafer.

11. A defect analysis method for a semiconductor device, comprising the steps of:
loading defect percentage data for each of inspection units within a wafer and an information piece for identifying a manufacturing apparatus which has processed the wafer from a database into a computer;
performing statistical testing of the defect percentage data with respect to the manufacturing apparatus using the computer; and
outputting results of the statistical testing for the information on the manufacturing apparatus from the computer in the form of map data corresponding to positions within a surface of the wafer.
